(19) United States
(12) Patent Application Publication
(10) Pub. No.: US 2020/0128788 A1
(43) Pub. Date: Apr. 30, 2020

(54) Collapsible Pet Bathing Structures

(71) Applicant: Arcia LLC, Walnut, CA (US)

(72) Inventor: Yu Martin Zheng, Walnut, CA (US)

(73) Assignee: Arcia LLC, Walnut, CA (US)

(21) Appl. No.: 16/174,043

(22) Filed: Oct. 29, 2018

(51) Int. Cl. A01K 13/00; A01K 15/04

(52) U.S. Cl. CPC A01K 13/001; A01K 15/04

(57) ABSTRACT

A collapsible structure is provided with a plurality of panels, the plurality of panels including at least a first panel and a second panel, each panel having a foldable frame member that has a folded and an unfolded orientation, with a meshed material covering portions of each respective frame member to form the panel for each frame member when the frame member is in the unfolded orientation. Each panel is hingedly coupled to an adjacent panel to define an interior. At least one panel has an opening, and a sleeve is secured to and extends from the opening.

### BACKGROUND OF THE INVENTION

### 1. Field of the Invention

The present invention relates to collapsible structures, and in particular, to collapsible structures that are made for use in bathing pet animals.

### 2. Description of the Prior Art

There are presently many collapsible structures that are being provided for use by children and adults in a number of different applications. Examples of these collapsible structures are illustrated in the following patents: U.S. Pat. No. 5,816,954 (Zheng), U.S. Pat. No. 6,006,772 (Zheng), U.S. Pat. No. 5,778,915 (Zheng), U.S. Pat. No. 5,467,794 (Zheng), U.S. Pat. No. 5,975,101 (Zheng), U.S. Pat. No. 5,722,446 (Zheng), U.S. Pat. No. 4,858,634 (McLeese), U.S. Pat. No. 4,825,592 (Norman), U.S. Pat. No. 5,964,533 (Ziglar), U.S. Pat. No. 5,971,188 (Kellogg et al.), U.S. Pat. No. 6,485,344 (Arias), U.S. Pat. No. 6,343,391 (LeGette), U.S. Pub. No. 2004/0139997 (Zheng) and U.S. Pat. No. 5,038,812 (Norman), among others. These collapsible structures are supported by one or more frame members that can be twisted and folded to reduce the overall size of the structure. These collapsible structures can be used in a wide variety of applications, such as containers, tents, play structures, executive toys, shelters, sports structures, and others. As a result, collapsible structures have become very popular.

Pets have become increasingly popular in recent times as people have been seeking companionship from a variety of pets. More and more pets are now living indoors, and there is now a real need to keep these pets clean. Certain pets, such as dogs and cats, require baths from time to time, and especially after they have been roaming or playing in the outside environment.

Giving a bath to a dog or cat can be a difficult task, especially since these animals do not like to get wet. Some of these animals will struggle, and in the ensuing struggle, often end up hurting the person who is trying to give the animal a bath. For example, a cat could claw the bath giver. Thus, there is a desire to provide an apparatus which would provide a bath giver some protection from the animal when he or she is giving the animal a bath.

### SUMMARY OF THE DISCLOSURE

It is an object of the present invention to provide an apparatus or device which protects the bath giver when he or she is giving an animal a bath.

In order to accomplish the objects of the present invention, a collapsible structure is provided with a plurality of panels, the plurality of panels including at least a first panel and a second panel, each panel having a foldable frame member that has a folded and an unfolded orientation, with a meshed material covering portions of each respective frame member to form the panel for each frame member when the frame member is in the unfolded orientation. Each panel is hingedly coupled to an adjacent panel to define an interior. At least one panel has an opening, and a sleeve is secured to and extends from the opening. An animal can be washed inside the interior, and a bath giver can extend his or her arms through the sleeve to access the animal. The panels and the sleeve would protect the bath giver.

### BRIEF DESCRIPTION OF THE DRAWINGS

FIG. 1 is a perspective view of a pet bathing structure according to one embodiment of the present invention.

FIG. 2 is a cross-sectional view of the section 2-2 in FIG. 1.

FIG. 3 is an expanded view of the area A in FIG. 1.

FIGS. 4A through 4E illustrate how the collapsible structure of FIG. 1 may be twisted and folded for compact storage.

FIGS. 5A-5C illustrate another embodiment of a sleeve according to the present invention.

FIG. 6A illustrates some modifications that can be provided to the structure of FIG. 1.

FIG. 6B illustrates a locking ring and corresponding D-ring.

FIG. 6C illustrates a zippered opening.

FIG. 6D illustrates an opening that is closed by Velcro™.

FIG. 7 illustrates a modification that can be made to the sleeve in FIGS. 5A-5C.

FIG. 8 illustrates the structure of FIG. 1 being used to wash a cat.

FIGS. 9-12 illustrate how the principles of the present invention are embodied in other collapsible structures.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

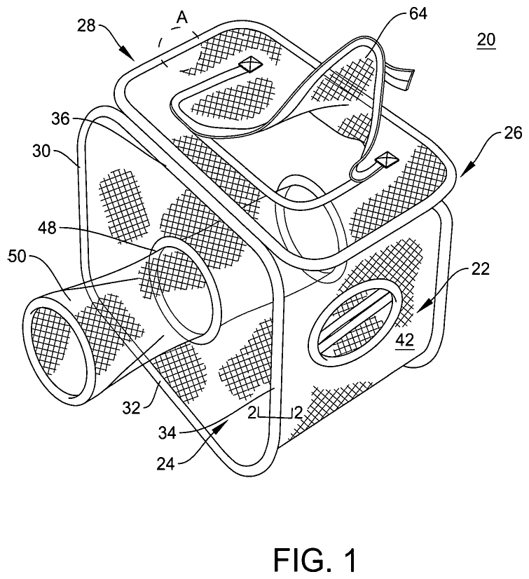

As shown in FIGS. 1-3 and 6A, a structure 20 is provided that comprises four panels 22, 24, 26 and 28 connected to each other to encircle an enclosed space. Each panel 22, 24, 26, 28 can have four sides, such as a left side 30, a bottom side 32, a right side 34 and a top side 36, although each panel 22, 24, 26, 28 can assume any configuration and have any number of sides. Each panel 22, 24, 26 and 28 has a frame retaining sleeve 38 provided along and traversing the four edges of its four sides 22, 24, 26, 28. A frame member 40 is retained or held within each respective frame retaining sleeve 38 to support each panel 22, 24, 26, 28. Only the frame member 40 is shown in FIG. 3; the other frame members are not shown but are the same as frame member 40.

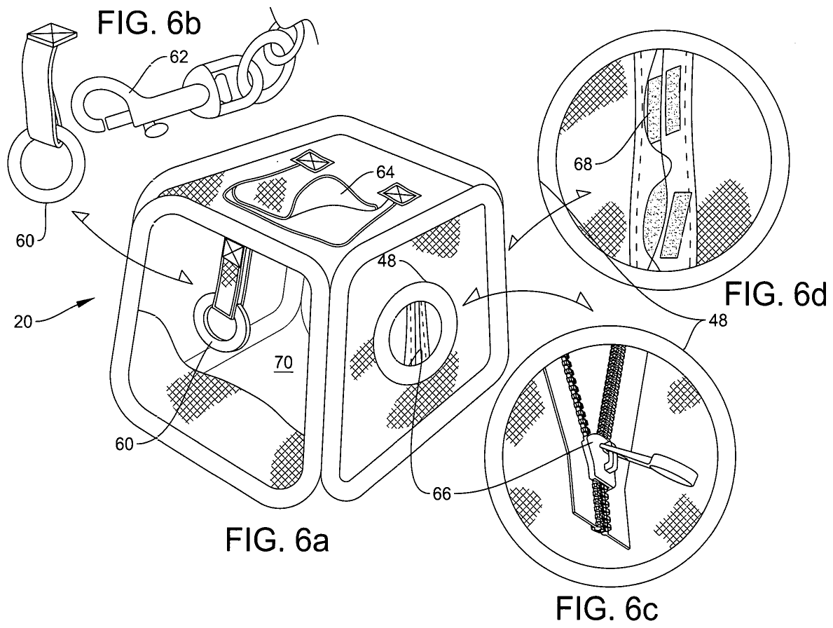

The frame members 40 may be provided as one continuous loop, or may comprise a strip of material connected at both ends to form a continuous loop. The frame members 40 are preferably formed of flexible coilable steel, although other materials such as plastics may also be used. The frame members should be made of a material which is relatively strong and yet is flexible to a sufficient degree to allow it to be coiled. Thus, each frame member 40 is capable of assuming two positions or orientations, an open or expanded position such as shown in FIG. 1, or a folded position in which the frame member is collapsed into a size which is much smaller than its open position (see FIG. 6D).

A fabric 42 extends across each respective panel 22, 24, 26, 28, and is held taut by the respective frame member 40 when in its open position. As used herein, the term fabric is intended to cover meshed material, or any other material with small openings that allow water to pass therethrough. The material should be made from strong, lightweight materials and may include woven fabrics. The fabric should be durable to withstand the wear and tear associated with rough treatment. The frame members 40 may be merely retained within the respective frame retaining sleeves 38 without being connected thereto. Alternatively, the frame retaining sleeves 38 may be mechanically fastened, stitched, fused, or glued to the respective frame members 40 respectively, to retain them in position.

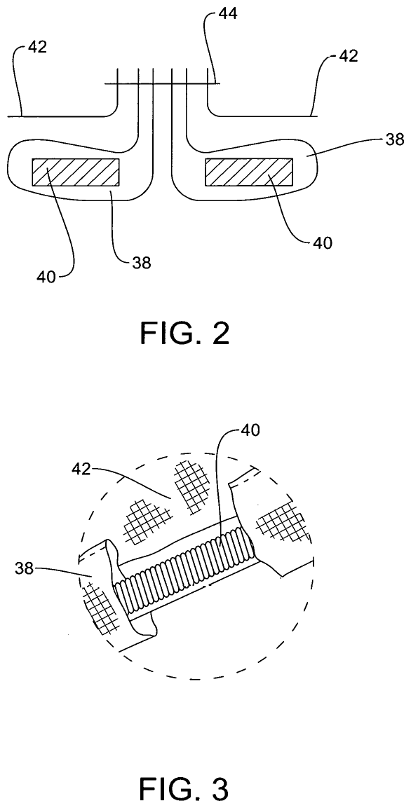

FIG. 2 illustrates one possible connection for connecting adjacent edges of two panels 22 and 24. The fabric pieces 42 are stitched at their edges by a stitching 44 to the respective sleeves 38. Each sleeve 38 may be formed by folding a piece of fabric. The stitching 44 also acts as a hinge for the panels 22 and 24 to be folded upon each other, as explained below. The connections for the three other pairs of adjacent edges may be identical. Thus, the connections on the left side 30 and the right side 34 of each panel 22, 24, 26, 28 act as hinge connections for connecting an adjacent panel.

At the top side 36 and the bottom side 32 of each panel 22, 24, 26, 28, where there is no hinge connection to an adjacent panel, the frame retaining sleeve 38 may be formed by merely folding over the corresponding fabric piece and applying a stitching. The fabric piece 42 for the corresponding panel may then be stitched to the sleeve 38.

Openings 48 can be provided in each of the panels 22, 24, 26, 28. As explained below, the openings 48 are preferably positioned at a vertical level which is not only above the bottom side 32 of the panels 22, 24, 26, 28, but at a level where a bath giver can comfortably extend his or her arm therethrough.

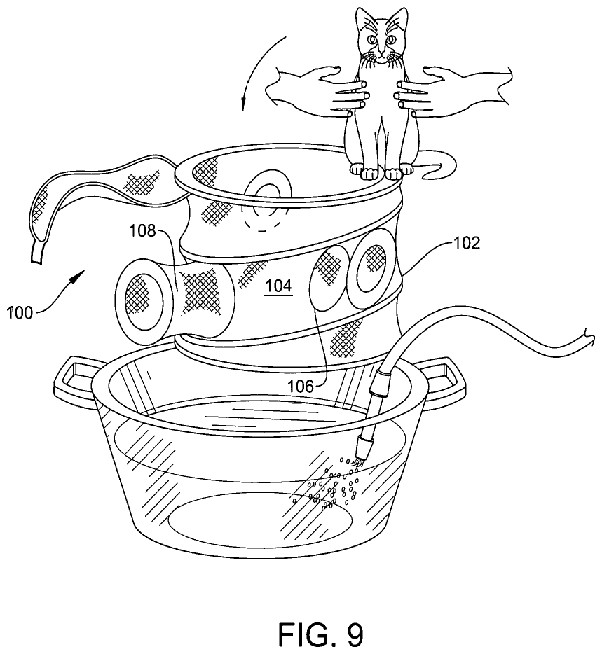

While the structure 20 of FIG. 1 is shown and described as having four panels, each having four sides, it will be appreciated that the structure 20 may be made of any number of panels, each having any number of sides, without departing from the spirit and scope of the present invention. For example, each structure may have at least one panel, and each panel may have three or more sides. Thus, the structures of the present invention may take a variety of external shapes. However, each panel, regardless of its shape, is supported by at least one frame member 40. Examples of other structures will be illustrated in FIGS. 9-12 below.

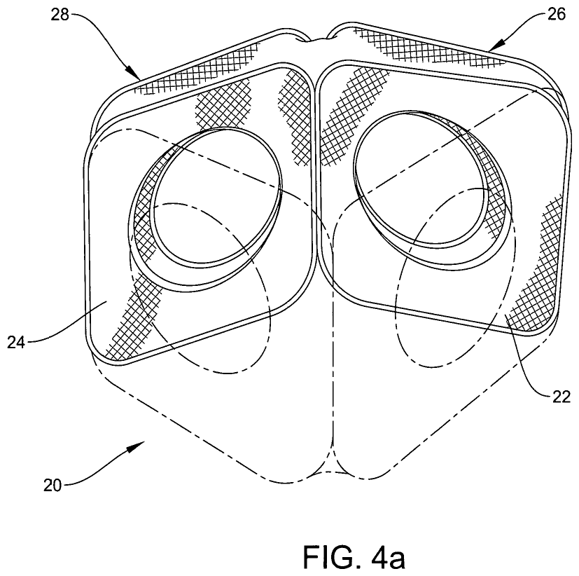

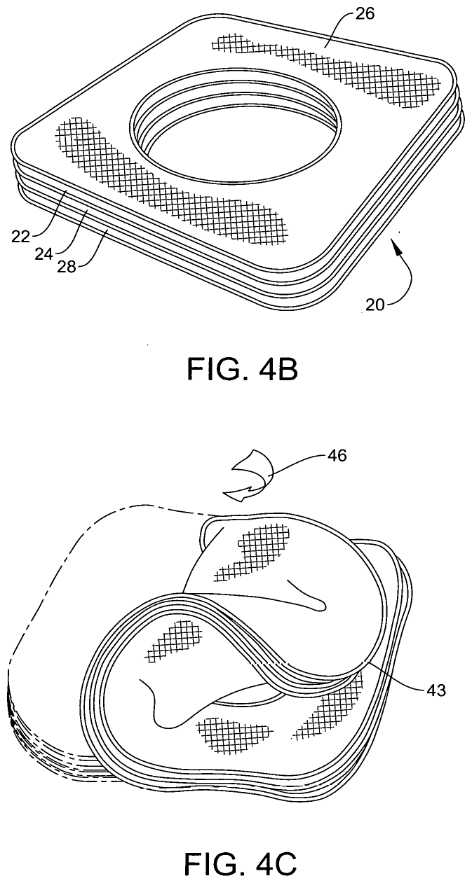

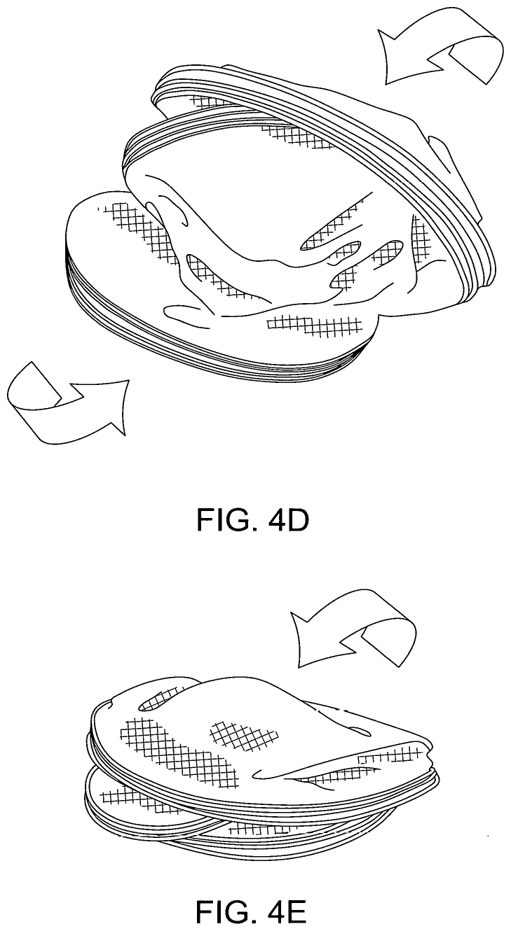

FIGS. 4A through 4E describe the various steps for folding and collapsing the structure 20 of FIG. 1 for storage. The first step consists of pushing panels 22 and 24 towards panels 26 and 28, respectively, about their hinged connections so that panel 22 collapses upon panel 26 and panel 24 collapses upon panel 28. Then, the two panels 22 and 26 are folded so as to be collapsed upon the two panels 24 and 28 to form a stack of four panels. See FIG. 4B. In the second step, the structure 20 is then twisted and folded to collapse the frame members 40 and panels 22, 24, 26, 28 into a smaller shape. In particular, the opposite border 43 of the stack of panels 22, 24, 26, 28 is folded in (see arrow 46 in FIG. 4C) upon the previous fold to further collapse the frame members 40 with the panels. As shown in FIGS. 4C and 4D, the folding is continued so that the initial size of the structure 20 is reduced until the frame members 40 and panels are collapsed on each other (see FIG. 4E) to provide for a small essentially compact configuration having a plurality of concentric frame members 40 and layers of the panels 22, 24, 26, 28 so that the collapsed structure 20 has a size which is a fraction of the size of the initial structure.

The present invention provides openings in the panels 22, 24, 26, 28 through which a bath giver can extend his or her arms into the interior of the structure 20. The pet or animal can be placed inside the structure, and then the bath giver can extend his or her arms through these openings to hold and clean the animal. The meshed material of the fabric 42 functions to protect the bath giver from being scratched or otherwise hurt by the animal.

The structure 20 is provided with several features that facilitate an improved cleaning experience for the bath giver. First, sleeves 50 can be provided (e.g., by stitching) at the openings 48. In one embodiment illustrated in FIG. 1, each sleeve 50 extends from the opening 48 in both directions; in other words, a part of the sleeve 50 extends outwardly from the opening 48 away from the interior of the structure 20, and part of the sleeve 50 extends into the interior of the structure 20. When used by a bath giver, the sleeves 50 essentially form an arm sleeve for the bath giver's arm, thereby providing additional protection from being scratched or hurt. The sleeves 50 are preferably made from a strong fabric material which is not limited to a meshed material, but can also include solid and durable fabrics that are resistant to tear or scratches.

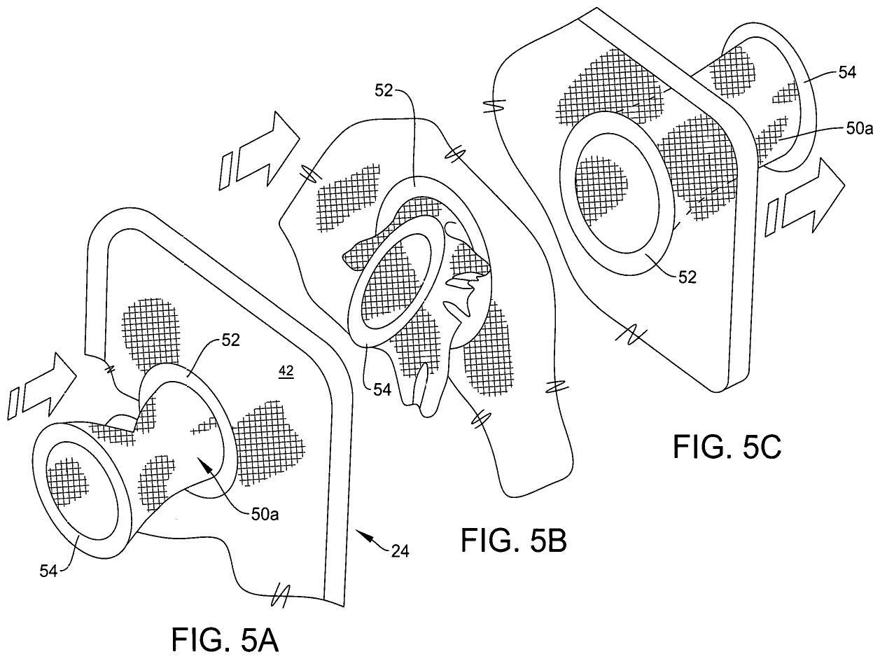

FIGS. 5A-5C illustrate another embodiment of a sleeve 50a according to the present invention. The opening 48 is provided with a ring-like loop 52 that is solid enough to maintain and define the shape of the opening 48. One end of the sleeve 50a is sewn or otherwise attached to the loop 52, and the other end of the sleeve 50a terminates in a rigid end loop 54 that also defines and maintains the shape of the opening for that end of the sleeve 50a. The end loop 54 can be pushed through the opening 48 (see FIG. 5B) to be inside the interior of the structure 20. See FIG. 5C. Thus, the bath giver can grab the end loop 54 and then push it through the opening 48, which results in the sleeve 50a covering his or her arm as the sleeve 50a is being pulled through the opening 48. In addition, the sleeve 50a would cover the arm inside the structure 20 while the bath giver is washing the animal.

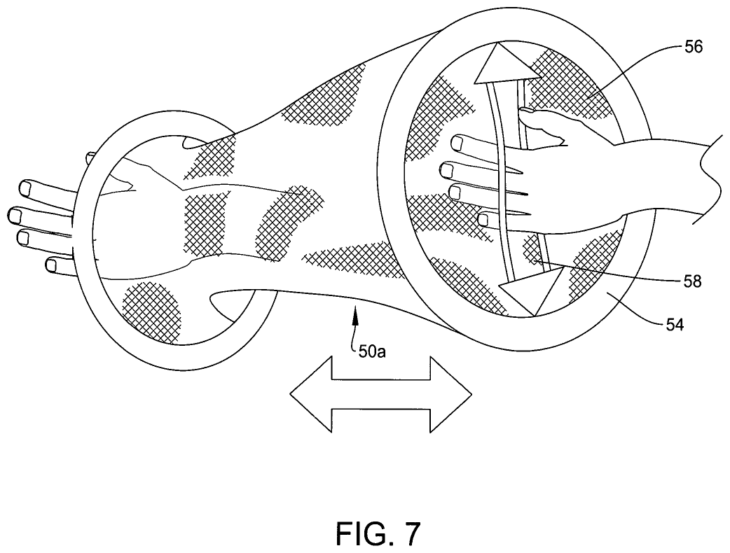

Referring to FIG. 7, the sleeve 50a can even be provided with a fabric cover 56 that covers the opening in the end loop 54. A slit 58 can be provided in this fabric cover 56 to allow a bath giver to extend his or her arm through the slit 58 and the sleeve 50a.

FIGS. 6A-6D illustrate other features of the structure 20 of the present invention. For example, a locking ring 60 can be secured to the frame retaining sleeve 38 of one or more panels 22, 24, 26, 28, and be used to removably secure a locking D-ring 62. Most pet collars have a locking D-ring 62, so the pet can be placed inside the structure 20 and the D-ring 62 on the collar can be locked to the locking ring 60 to prevent the pet from escaping from inside the structure 20.

FIGS. 1, 6A and 6C also illustrate other alternatives to the openings 48. For example, a flap 64 can be provided to cover any of the openings 48. The flap 64 can be used instead of a sleeve 50, and functions to cover the opening 48. This can be helpful during a bath as the flap 64 itself provides some protection to the bath giver, while also covering the opening 48 to prevent the pet or water from escaping.

In addition, any of the openings 48 can be provided with a zipper 66 to close or cover two fabric pieces at the opening 48 (FIG. 6C) or Velcro™ pads 68 can be used to close or cover two fabric pieces at the opening 48 (FIG. 6D).

Other modifications and alternatives can also be provided for the structure 20. First, a fabric floor 70 (see FIG. 6A) can be stitched to the bottom sides 32 of each panel 22, 24, 26, 28. In addition, even though FIGS. 1 and 6 show that the top of the structure 20 has a fabric piece with a flap 64 covering an opening, it is possible to provide the top of the structure with no fabric whatsoever, so that the top of the structure 20 is completely opened and exposed. This can be helpful in placing and removing a large animal into the interior of the structure 20.

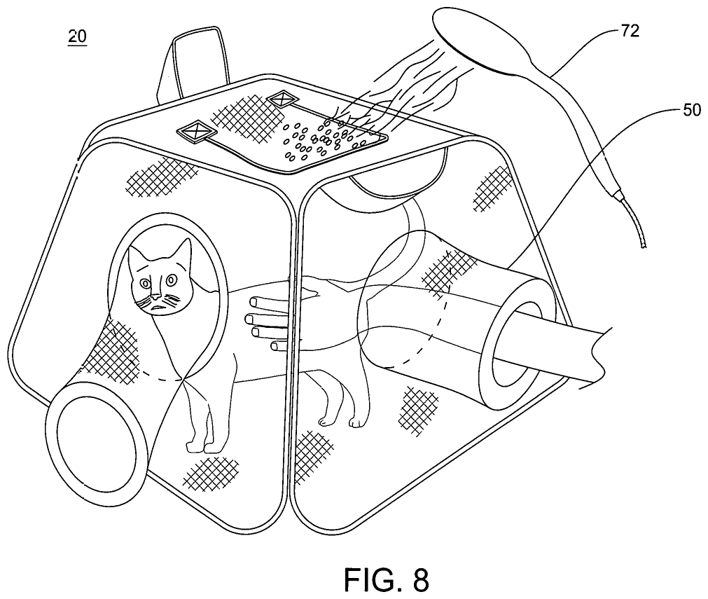

FIG. 8 illustrates the structure of FIG. 1 being used to wash a cat. The cat is placed inside the structure, and the bath giver extends an arm through a sleeve 50 in one of the panels 22, 24, 26, 28. A faucet or hose 72 can be held above the top of the structure 20 to provide water for rinsing.

One benefit provided by the structure 20 of the present invention is that the structure 20 can be folded and collapsed when it is not in use, thereby conserving storage space.

FIGS. 9-12 illustrate how the principles of the present invention are embodied in other known collapsible structures.

FIG. 9 illustrates a tunnel-like structure 100 which is similar to the structures shown and illustrated in U.S. Pat. No. 8,021,272, whose entire disclosure is incorporated by this reference as though fully set forth herein. The structure 100 has an internal support wire 102 that is covered by a covering 104 to define a tunnel-like interior passageway. Openings 106 can be provided in the covering 104 and sleeves 108 can be provided at the openings 106. One benefit of this structure 100 is that it can be conveniently placed inside a tub of water as shown in FIG. 9.

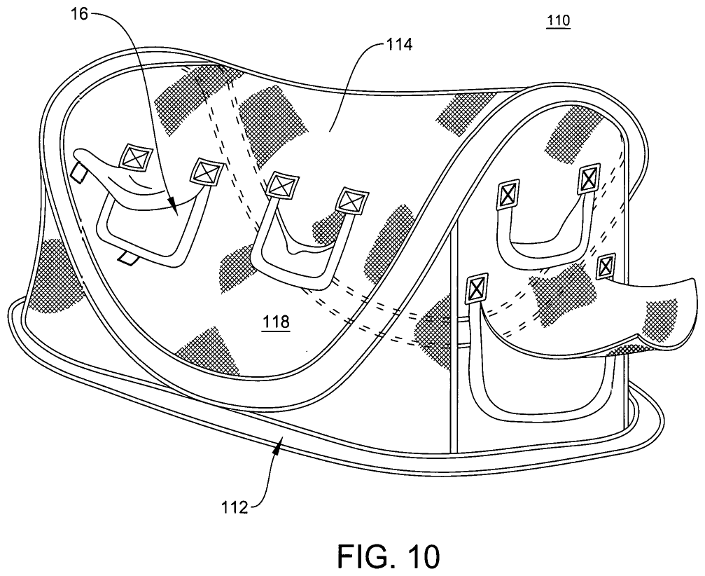

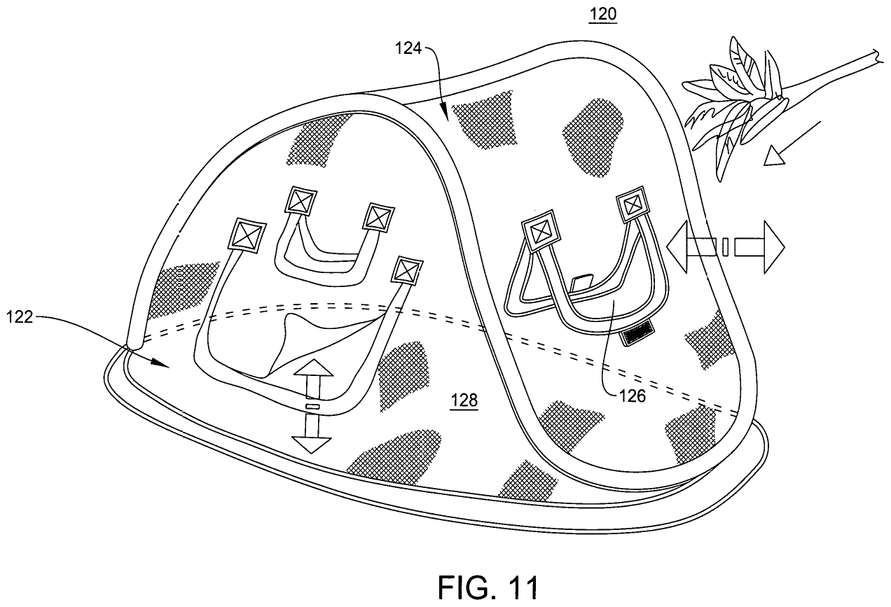

FIGS. 10 and 11 illustrate structures 110 and 120 which are similar to the structures shown and illustrated in U.S. Pat. No. 6,098,349, whose entire disclosure is incorporated by this reference as though fully set forth herein. The structures 110 and 120 all have a base or floor panel 112 and 122, respectively, which is covered by a bent or curved upper panel 114 and 124, respectively. Openings 116 and 126, respectively, can be provided in the fabric 118 and 128, respectively, for access into the interior of the structures 110 and 120, respectively. Sleeves (not shown) can be attached to these openings 116 and 126 in the same manner as described above.

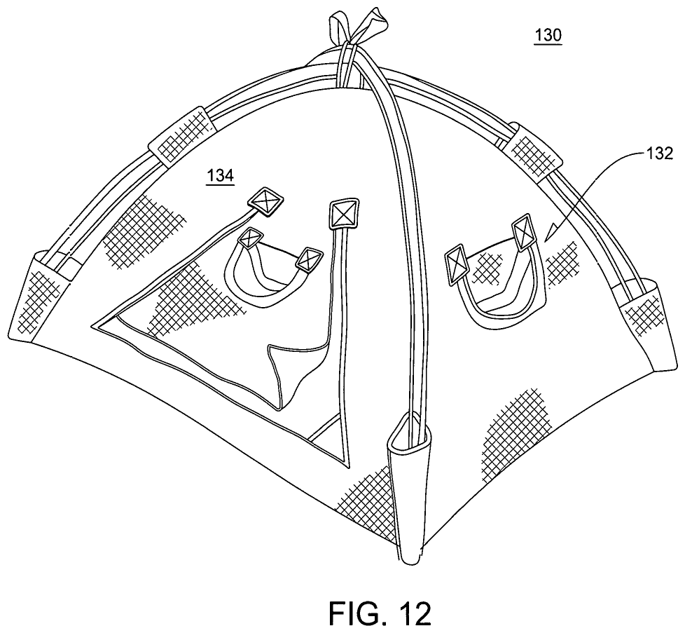

FIG. 12 illustrates a structure 130 which is similar to the structure shown and illustrated in FIG. 17 of U.S. Pat. No. 7,836,906, whose entire disclosure is incorporated by this reference as though fully set forth herein. Openings 132 can be provided in the fabric 134 for access into the interior of the structure 130. Sleeves (not shown) can be attached to these openings 132 in the same manner as described above.

In all of these structures 100, 110, 120 and 130, the animal can be placed inside the structure and the bath giver can access the interior of the structure through the sleeves and the openings in the panels. The panels and the sleeves provide protection to the bath giver.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A collapsible structure comprising a plurality of panels, the plurality of panels including at least a first panel and a second panel, each panel having a foldable frame member that has a folded and an unfolded orientation, with a meshed material covering portions of each respective frame member to form the panel for each frame member when the frame member is in the unfolded orientation, with each panel being hingedly coupled to an adjacent panel to define an interior, and with at least one panel having an opening; and
a sleeve secured to and extending from the opening.

2. The structure of claim 1, wherein each panel having a left side and a right side, with the left side of one panel hingedly coupled to the right side of an adjacent panel to define the interior.

3. The structure of claim 1, wherein the sleeve has a first part that extends into the interior of the structure, and a second part that extends outside the structure.

4. The structure of claim 1, wherein the sleeve has a first end that is secured to the opening, and a second end, with an end loop provided at the second end, and wherein the end loop can be extended through the opening into the interior of the structure.

5. The structure of claim 4, wherein the end loop is provided with a covering that has a slit provided in the covering.

6. The structure of claim 1, wherein each panel has a frame retaining sleeve that retains the respective frame member for the panel.

7. The structure of claim 1, further including a locking ring secured to the interior of the structure.

8. The structure of claim 1, wherein each panel is provided with an opening, and wherein one of the openings has a zippered covering.

9. The structure of claim 1, wherein each panel is provided with an opening, and wherein one of the openings has a Velcro™ covering.

10. The structure of claim 1, wherein each panel is provided with an opening, and wherein one of the openings has a flap covering.

11. A method of bathing a pet, comprising:
providing a collapsible structure comprising:
a plurality of panels, the plurality of panels including at least a first panel and a second panel, each panel having a foldable frame member that has a folded and an unfolded orientation, with a meshed material covering portions of each respective frame member to form the panel for each frame member when the frame member is in the unfolded orientation, each panel being hingedly coupled to an adjacent panel to define an interior, and with at least one panel having an opening; and
a sleeve secured to and extending from the opening;
placing a pet inside the interior of the structure; and
extending an arm through the sleeve from outside the structure to the interior of the structure to clean the pet.

12. The method of claim 11, wherein each panel having a left side and a right side, with the left side of one panel hingedly coupled to the right side of an adjacent panel to define the interior.

13. The method of claim 11, wherein the sleeve has a first part that extends into the interior of the structure, and a second part that extends outside the structure.

14. The method of claim 11, wherein the sleeve has a first end that is secured to the opening, and a second end, with an end loop provided at the second end, and further including the step of grabbing the end loop and extending the end loop through the opening into the interior of the structure.

15. The method of claim 14, wherein the end loop is provided with a covering that has a slit provided in the covering.

16. The method of claim 11, further including:
providing a locking ring secured to the interior of the structure; and
locking a D-ring from the pet's collar with the locking ring.
